(19) United States
(12) Patent Application Publication
(10) Pub. No.: US 2024/0096049 A1
(43) Pub. Date: Mar. 21, 2024

(54) EXPOSURE CONTROL BASED ON SCENE DEPTH

(71) Applicant: QUALCOMM Incorporated, San Diego, CA (US)

(72) Inventors: Vinod Kumar SAINI, Bengaluru (IN); Pushkar GORUR SHESHAGIRI, Bengaluru (IN); Srujan Babu NANDIPATI, Bangalore (IN); Chiranjib CHOUDHURI, Bangalore (IN); Ajit Deepak GUPTE, Bangalore (IN)

(21) Appl. No.: 17/933,334

(22) Filed: Sep. 19, 2022

(51) Int. Cl. G06V 10/60; G06T 7/11; G06T 7/20; G06T 7/70; G06T 17/05; G06V 10/25; G06V 10/44; G06V 20/50

(52) U.S. Cl. CPC G06V 10/60; G06T 7/11; G06T 7/20; G06T 7/70; G06T 17/05; G06V 10/25; G06V 10/44; G06V 20/50; G06T 2207/10028; G06T 2207/10144; G06V 2201/07

(57) ABSTRACT

Disclosed are systems, apparatuses, processes, and computer-readable media to capture images with subjects at different depths. A method of processing image data includes obtaining, at an imaging device, a first image of an environment from an image sensor of the imaging device; determining a region of interest of the first image based on features depicted in the first image, wherein the features are associated with the environment; determining a representative luma value associated with the first image based on image data in the region of interest of the first image; determining one or more exposure control parameters based on the representative luma value; and obtaining, at the imaging device, a second image captured based on the one or more exposure control parameters.

### FIELD

This application is related to image processing. More specifically, this application relates to systems and techniques for performing exposure control based on scene depth.

### BACKGROUND

Many devices and systems allow a scene to be captured by generating images (or frames) and/or video data (including multiple frames) of the scene. For example, a camera or a device including a camera (or cameras) can capture a sequence of frames of a scene (e.g., a video of a scene) based on light captured by an image sensor of the camera and processed by a processor of the camera. To enhance a quality of frames captured by the camera, the camera may include lenses to focus light entering the camera. In some cases, a camera or device including a camera (or cameras) can include an exposure control mechanism can control a size of an aperture of the camera, a duration of time for which the aperture is open, a duration of time for which an image sensor of the camera collects light, a sensitivity of the image sensor, analog gain applied by the image sensor, or any combination thereof. The sequence of frames captured by the camera can be output for display, can be output for processing and/or consumption by other devices, among other uses.

### SUMMARY

In some examples, systems and techniques are described for performing exposure control based on scene depth. According to at least one example, a method for processing one or more images is provided. The method includes: obtaining, at an imaging device, a first image of an environment from an image sensor of the imaging device; determining a region of interest of the first image based on features depicted in the first image, wherein the features are associated with the environment; determining a representative luma value associated with the first image based on image data in the region of interest of the first image; determining one or more exposure control parameters based on the representative luma value; and obtaining, at the imaging device, a second image captured based on the one or more exposure control parameters.

In another example, an apparatus for processing one or more images is provided that includes at least one memory and at least one processor coupled to the at least one memory. The at least one processor is configured to: obtain a first image of an environment from an image sensor of the imaging device; determine a region of interest of the first image based on features depicted in the first image, wherein the features are associated with the environment; determine a representative luma value associated with the first image based on image data in the region of interest of the first image; determine one or more exposure control parameters based on the representative luma value; and obtain a second image captured based on the one or more exposure control parameters.

In another example, a non-transitory computer-readable medium is provided that has stored thereon instructions that, when executed by one or more processors, cause the one or more processors to: obtain, at an imaging device, a first image of an environment from an image sensor of the imaging device; determine a region of interest of the first image based on features depicted in the first image, wherein the features are associated with the environment; determine a representative luma value associated with the first image based on image data in the region of interest of the first image; determine one or more exposure control parameters based on the representative luma value; and obtain, at the imaging device, a second image captured based on the one or more exposure control parameters.

In another example, an apparatus for processing one or more images is provided. The apparatus includes: means for obtaining a first image of an environment from an image sensor of the imaging device; means for determining a region of interest of the first image based on features depicted in the first image, wherein the features are associated with the environment; means for determining a representative luma value associated with the first image based on image data in the region of interest of the first image; means for determining one or more exposure control parameters based on the representative luma value; and means for obtaining a second image captured based on the one or more exposure control parameters.

In some aspects, the apparatus is, is part of, and/or includes a wearable device, an extended reality (XR) device (e.g., a virtual reality (VR) device, an augmented reality (AR) device, or a mixed reality (MR) device), a head-mounted device (HMD) device, a wireless communication device, a mobile device (e.g., a mobile telephone and/or mobile handset and/or so-called “smartphone” or another mobile device), a camera, a personal computer, a laptop computer, a server computer, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensors).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

Illustrative embodiments of the present application are described in detail below with reference to the following figures:

FIG. 1 is a block diagram illustrating an example of an architecture of an image capture and processing device, in accordance with some examples;

FIG. 2 is a conceptual diagram illustrating an example of a technique for performing visual simultaneous localization and mapping (VSLAM) using a camera of a VSLAM device, in accordance with some examples;

FIG. 3A is a block diagram of a device that performs VSLAM or another localization technique, in accordance with some examples;

FIG. 3B is a block diagram of another device that performs another localization technique with depth sensor, in accordance with some examples;

FIG. 4 is an example image generated in a poorly lit environment by a device configured to perform localization techniques in accordance with some aspects of the disclosure;

FIG. 5 is an example image generated by a device configured to control an image sensor for localization techniques in accordance with some aspects of the disclosure;

FIG. 6A illustrates an example of a visualization of three-dimensional (3D) point cloud by a computing device that identifies a region of interest in accordance with some aspects of the disclosure;

FIG. 6B illustrates an example of a visualization of 3D point cloud by a computing device that identifies a region of interest in accordance with some aspects of the disclosure;

FIG. 7A is a perspective diagram illustrating a ground vehicle that performs VSLAM or another localization technique, in accordance with some examples;

FIG. 7B is a perspective diagram illustrating an airborne vehicle that performs VSLAM or another localization technique, in accordance with some examples;

FIG. 8A is a perspective diagram illustrating a head-mounted display (HMD) that performs VSLAM or another localization technique, in accordance with some examples;

FIG. 8B is a perspective diagram illustrating the HMD of FIG. 7A being worn by a user, in accordance with some examples;

FIG. 8C is a perspective diagram illustrating a front surface of a mobile handset that performs VSLAM or another localization technique using front-facing cameras, in accordance with some examples;

FIG. 8D is a perspective diagram illustrating a rear surface of a mobile handset that performs VSLAM or another localization technique using rear-facing cameras, in accordance with some examples;

FIG. 9 is a flow diagram illustrating an example of an image processing technique, in accordance with some examples; and

FIG. 10 is a diagram illustrating an example of a system for implementing certain aspects of the present technology.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The ensuing description provides example aspects only and is not intended to limit the scope, applicability, or configuration of the disclosure. Rather, the ensuing description of the exemplary aspects will provide those skilled in the art with an enabling description for implementing an aspect of the disclosure. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

An image capture device (e.g., a camera) is a device that receives light and captures image frames, such as still images or video frames, using an image sensor. The terms “image,” “image frame,” and “frame” are used interchangeably herein. An image capture device typically includes at least one lens that receives light from a scene and bends the light toward an image sensor of the image capture device. The light received by the lens passes through an aperture controlled by one or more control mechanisms and is received by the image sensor. The one or more control mechanisms can control exposure, focus, and/or zoom based on information from the image sensor and/or based on information from an image processor (e.g., a host or application process and/or an image signal processor). In some examples, the one or more control mechanisms include a motor or other control mechanism that moves a lens of an image capture device to a target lens position.

Localization is general description of a positioning technique that is used to identify a position of an object in an environment. An example of a localization technique is a global positioning system (GPS) for identifying a position of an outdoor environment. Other types of localization techniques use angle of arrival (AoA), time of arrival (ToA), received signal strength indicators (RSSI) to identify positions of an object within the environment.

Simultaneous localization and mapping (SLAM) is a localization technique used in devices such as robotics systems, autonomous vehicle systems, extended reality (XR) systems, head-mounted displays (HMD), among others. As noted above, XR systems can include, for instance, augmented reality (AR) systems, virtual reality (VR) systems, and mixed reality (MR) systems. XR systems can be HMD devices. Using SLAM, a device can construct and update a map of an unknown environment while simultaneously keeping track of the device's location within that environment. The device can generally perform these tasks based on sensor data collected by one or more sensors on the device. For example, the device may be activated in a particular room of a building, and may move throughout the building, mapping the entire interior of the building while tracking its own location within the map as the device develops the map.

Visual SLAM (VSLAM) is a SLAM technique that performs mapping and localization based on visual data collected by one or more cameras of a device. In some cases, a monocular VSLAM device can perform VSLAM using a single camera. For example, the monocular VSLAM device can capture one or more images of an environment with the camera and can determine distinctive visual features, such as corner points or other points in the one or more images. The device can move through the environment and can capture more images. The device can track movement of those features in consecutive images captured while the device is at different positions, orientations, and/or poses in the environment. The device can use these tracked features to generate a three-dimensional (3D) map and determine its own positioning within the map.

VSLAM can be performed using visible light (VL) cameras that detect light within the light spectrum visible to the human eye. Some VL cameras detect only light within the light spectrum visible to the human eye. An example of a VL camera is a camera that captures red (R), green (G), and blue (B) image data (referred to as RGB image data). The RGB image data can then be merged into a full-color image. VL cameras that capture RGB image data may be referred to as RGB cameras. Cameras can also capture other types of color images, such as images having luminance (Y) and Chrominance (Chrominance blue, referred to as U or Cb, and Chrominance red, referred to as V or Cr) components. Such images can include YUV images, YC_{b}Cᵣ images, etc.

In some environments (e.g., outdoor environments), image features may be randomly distributed with varying depths (e.g., depths varying from less than a meter to thousands of meters). In general, nearby features provide better pose estimates, in which case it is desirable to track as many nearby features as possible. However, due to varying light condition in certain environments (e.g., outdoor environments), nearby objects may be overexposed or underexposed, which can make feature tracking of nearby features difficult. For example, VL cameras may capture clear images of well-illuminated and indoor environments. Features such as edges and corners may be easily discernable in clear images of well-illuminated environments. However, VL cameras may have difficulty in outdoor environments that have large dynamic ranges. For example, light regions and shaded regions in outdoor environments can be very different based on a position of the sun and extremely light regions may cause the camera to capture an environment with a low exposure, which causes shaded regions to be darker. In some cases, the identification of objects within the shaded region may be difficult based on the different amount of light in the environment. For example, the light regions may be far away and the shaded regions may be closer. As a result, a tracking device (e.g., a VSLAM device) using a VL camera can sometimes fail to recognize portions of an environment that the VSLAM device has already observed due to the lighting conditions in the environment. Failure to recognize portions of the environment that a VSLAM device has already observed can cause errors in localization and/or mapping by the VSLAM device.

Systems, apparatuses, electronic devices or apparatuses, methods (also referred to as processes), and computer-readable media (collectively referred to herein as “systems and techniques”) are described herein for performing exposure control based on scene depth. For example, the systems and techniques can capture images in environments that have dynamic lighting conditions or regions that have different lighting conditions and adjust the image exposure settings based on depths of objects within the environment and corresponding lighting associated with those objects. For example, the systems and techniques can perform localization using an image sensor (e.g., a visible light (VL) camera, an IR camera) and/or a depth sensor.

In one illustrative example, a system or device can obtain (e.g., capture) a first image of an environment from an image sensor of the imaging device and determine a region of interest of the first image based on features depicted in the first image. The region of interest may include the features are associated with the environment that can be used for tracking and localization. The device can determine a representative luma value (e.g., an average luma value) associated with the first image based on image data in the region of interest of the first image. After determining the representative luma, the device may determine one or more exposure control parameters based on the representative luma value. The device can then obtain a second image captured based on the exposure control parameters. In one aspect, if the region of interest is dark and has a low luma value, the device may increase the exposure time to increase the brightness of the region of interest. The device can also decrease the exposure time, or may perform other changes such as increase a gain of the image sensor, which amplifies the brightness of portions.

Further details regarding the systems and techniques are provided herein with respect to various figures. While some examples described herein use SLAM as an example of an application that can use the exposure control systems and techniques described herein, such techniques can be used by any system that captures images and/or uses images for one or more operations.

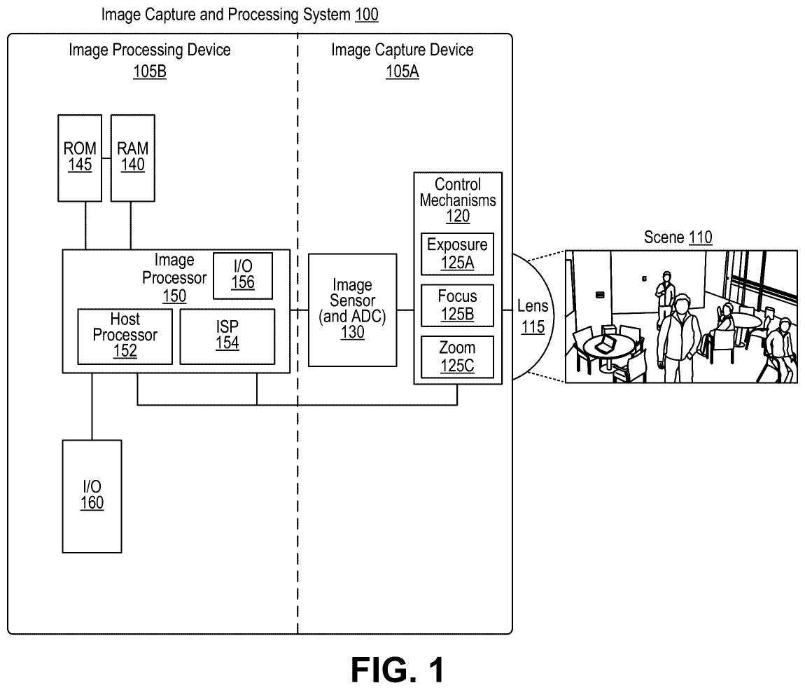

FIG. 1 is a block diagram illustrating an example of an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting, an image acquisition setting, and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors (e.g., image sensor 130) may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 1810 discussed with respect to the computing device 1800. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocols or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1020, read-only memory (ROM) 145/1025, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1835, any other input devices 1845, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the system 100 and one or more peripheral devices, over which the system 100 may receive data from the one or more peripheral devices and/or transmit data to the one or more peripheral devices. The I/O 160 may include one or more wireless transceivers that enable a wireless connection between the system 100 and one or more peripheral devices, over which the system 100 may receive data from the one or more peripheral devices and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

In some cases, the image capture and processing system 100 can be part of or implemented by a device that can perform localization or a type of localization such as VSLAM (referred to as a VSLAM device). For example, a VSLAM device may include one or more image capture and processing system(s) 100, image capture system(s) 105A, image processing system(s) 105B, computing system(s) 1000, or any combination thereof. For example, a VSLAM device can include at least one image sensor and a depth sensor. The VL camera and the IR camera can each include at least one of the image capture and processing system 100, the image capture device 105A, the image processing device 105B, a computing system 1800, or some combination thereof.

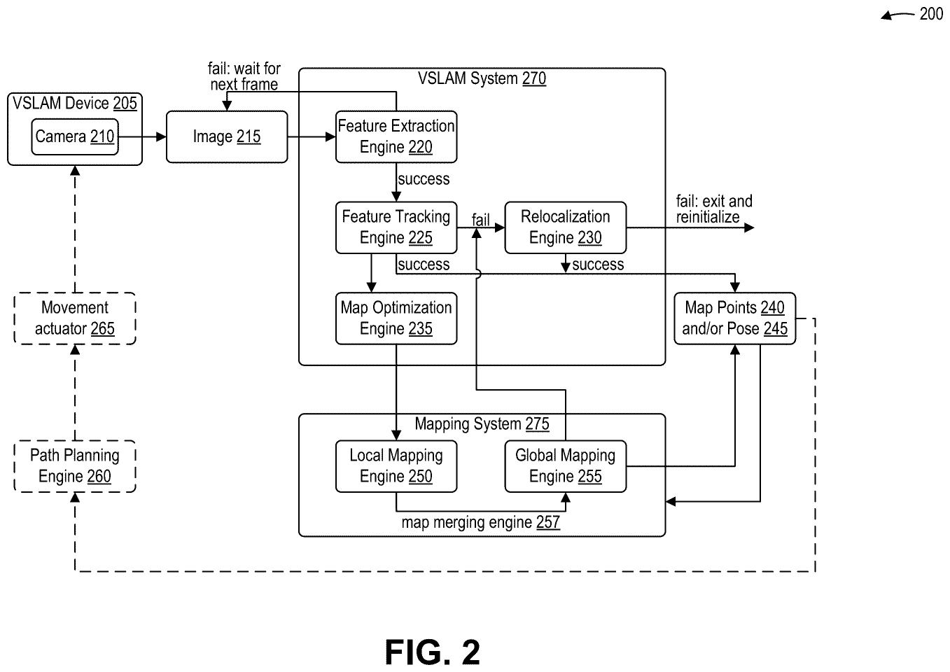

FIG. 2 is a conceptual diagram 200 illustrating an example of a technique for performing visual VSLAM using a camera 210 of a VSLAM device 205. In some examples, the VSLAM device 205 can be a VR device, an AR device, a MR device, an XR device, a HMD, or some combination thereof. In some examples, the VSLAM device 205 can be a wireless communication device, a mobile device (e.g., a mobile telephone or so-called “smart phone” or other mobile device), a wearable device, an extended reality (XR) device (e.g., a VR device, an AR device, or a MR device), a HMD, a personal computer, a laptop computer, a server computer, an unmanned ground vehicle, an unmanned aerial vehicle, an unmanned aquatic vehicle, an unmanned underwater vehicle, an unmanned vehicle, an autonomous vehicle, a vehicle, a robot, any combination thereof, and/or other device.

The VSLAM device 205 includes a camera 210. The camera 210 may be responsive to light from a particular spectrum of light. The spectrum of light may be a subset of the electromagnetic (EM) spectrum. For example, the camera 210 may be a camera responsive to a visible spectrum, an IR camera responsive to an IR spectrum, an ultraviolet (UV) camera responsive to a UV spectrum, a camera responsive to light from another spectrum of light from another portion of the electromagnetic spectrum, or a some combination thereof. In some cases, the camera 210 may be a near-infrared (NIR) camera responsive to aNIR spectrum. The NIR spectrum may be a subset of the IR spectrum that is near and/or adjacent to the VL spectrum.

The camera 210 can be used to capture one or more images, including an image 215. A VSLAM system 270 can perform feature extraction using a feature extraction engine 220. The feature extraction engine 220 can use the image 215 to perform feature extraction by detecting one or more features within the image. The features may be, for example, edges, corners, areas where color changes, areas where luminosity changes, or combinations thereof. In some cases, feature extraction engine 220 can fail to perform feature extraction for an image 215 when the feature extraction engine 220 fails to detect any features in the image 215. In some cases, feature extraction engine 220 can fail when it fails to detect at least a predetermined minimum number of features in the image 215. If the feature extraction engine 220 fails to successfully perform feature extraction for the image 215, the VSLAM system 270 does not proceed further, and can wait for the next image frame captured by the camera 210.

The feature extraction engine 220 can succeed in perform feature extraction for an image 215 when the feature extraction engine 220 detects at least a predetermined minimum number of features in the image 215. In some examples, the predetermined minimum number of features can be one, in which case the feature extraction engine 220 succeeds in performing feature extraction by detecting at least one feature in the image 215. In some examples, the predetermined minimum number of features can be greater than one, and can for example be 2, 3, 4, 5, 10, 15, 20, 25, 30, 35, 40, 45, 50, 55, 60, 65, 70, 75, 80, 85, 90, 95, 100, a number greater than 100, or a number between any two previously listed numbers. Images with one or more features depicted clearly may be maintained in a map database as keyframes, whose depictions of the features may be used for tracking those features in other images.

The VSLAM system 270 can perform feature tracking using a feature tracking engine 225 once the feature extraction engine 220 succeeds in performing feature extraction for one or more images 215. The feature tracking engine 225 can perform feature tracking by recognizing features in the image 215 that were already previously recognized in one or more previous images. The feature tracking engine 225 can also track changes in one or more positions of the features between the different images. For example, the feature extraction engine 220 can detect a particular person's face as a feature depicted in a first image. The feature extraction engine 220 can detect the same feature (e.g., the same person's face) depicted in a second image captured by and received from the camera 210 after the first image. Feature tracking 225 can recognize that these features detected in the first image and the second image are two depictions of the same feature (e.g., the same person's face). The feature tracking engine 225 can recognize that the feature has moved between the first image and the second image. For instance, the feature tracking engine 225 can recognize that the feature is depicted on the right-hand side of the first image, and is depicted in the center of the second image.

Movement of the feature between the first image and the second image can be caused by movement of a photographed object within the photographed scene between capture of the first image and capture of the second image by the camera 210. For instance, if the feature is a person's face, the person may have walked across a portion of the photographed scene between capture of the first image and capture of the second image by the camera 210, causing the feature to be in a different position in the second image than in the first image. Movement of the feature between the first image and the second image can be caused by movement of the camera 210 between capture of the first image and capture of the second image by the camera 210. In some examples, the VSLAM device 205 can be a robot or vehicle, and can move itself and/or its camera 210 between capture of the first image and capture of the second image by the camera 210. In some examples, the VSLAM device 205 can be a head-mounted display (HMD) (e.g., an XR headset) worn by a user, and the user may move his or her head and/or body between capture of the first image and capture of the second image by the camera 210.

The VSLAM system 270 may identify a set of coordinates, which may be referred to as a map point, for each feature identified by the VSLAM system 270 using the feature extraction engine 220 and/or the feature tracking engine 225. The set of coordinates for each feature may be used to determine map points 240. The local map engine 250 can use the map points 240 to update a local map. The local map may be a map of a local region of the map of the environment. The local region may be a region in which the VSLAM device 205 is currently located. The local region may be, for example, a room or set of rooms within an environment. The local region may be, for example, the set of one or more rooms that are visible in the image 215. The set of coordinates for a map point corresponding to a feature may be updated to increase accuracy by the VSLAM system 270 using the map optimization engine 235. For instance, by tracking a feature across multiple images captured at different times, the VSLAM system 270 can generate a set of coordinates for the map point of the feature from each image. An accurate set of coordinates can be determined for the map point of the feature by triangulating or generating average coordinates based on multiple map points for the feature determined from different images. The map optimization 235 engine can update the local map using the local mapping engine 250 to update the set of coordinates for the feature to use the accurate set of coordinates that are determined using triangulation and/or averaging. Observing the same feature from different angles can provide additional information about the true location of the feature, which can be used to increase accuracy of the map points 240.

The local map 250 may be part of a mapping system 275 along with a global map 255. The global map 255 may map a global region of an environment. The VSLAM device 205 can be positioned in the global region of the environment and/or in the local region of the environment. The local region of the environment may be smaller than the global region of the environment. The local region of the environment may be a subset of the global region of the environment. The local region of the environment may overlap with the global region of the environment. In some cases, the local region of the environment may include portions of the environment that are not yet merged into the global map by the map merging engine 257 and/or the global mapping engine 255. In some examples, the local map may include map points within such portions of the environment that are not yet merged into the global map. In some cases, the global map 255 may map all of an environment that the VSLAM device 205 has observed. Updates to the local map by the local mapping engine 250 may be merged into the global map using the map merging engine 257 and/or the global mapping engine 255, thus keeping the global map up to date. In some cases, the local map may be merged with the global map using the map merging engine 257 and/or the global mapping engine 255 after the local map has already been optimized using the map optimization engine 235, so that the global map is an optimized map. The map points 240 may be fed into the local map by the local mapping engine 250, and/or can be fed into the global map using the global mapping engine 255. The map optimization engine 235 may improve the accuracy of the map points 240 and of the local map and/or global map. The map optimization engine 235 may, in some cases, simplify the local map and/or the global map by replacing a bundle of map points with a centroid map point.

The VSLAM system 270 may also determine a pose 245 of the device 205 based on the feature extraction and/or the feature tracking performed by the feature extraction engine 220 and/or the feature tracking engine 225. The pose 245 of the device 205 may refer to the location of the device 205, the orientation of the device 205 (e.g., represented as a pitch roll, and yaw of the device 205, a quaternion, SE3, direction cosine matrix (DCM), or any combination thereof). The pose 245 of the device 205 may refer to the pose of the camera 210, and may thus include the location of the camera 210 and/or the orientation of the camera 210. The pose 245 of the device 205 may be determined with respect to the local map and/or the global map. The pose 245 of the device 205 may be marked on local map by the local mapping engine 250 and/or on the global map by the global mapping engine 255. In some cases, a history of poses 245 may be stored within the local map and/or the global map by the local mapping engine 250 and/or by the global mapping engine 255. The history of poses 245, together, may indicate a path that the VSLAM device 205 has traveled.

In some cases, the feature tracking engine 225 can fail to successfully perform feature tracking for an image 215 when no features that have been previously recognized in a set of earlier-captured images are recognized in the image 215. In some examples, the set of earlier-captured images may include all images captured during a time period ending before capture of the image 215 and starting at a predetermined start time. The predetermined start time may be an absolute time, such as a particular time and date. The predetermined start time may be a relative time, such as a predetermined amount of time (e.g., 30 minutes) before capture of the image 215. The predetermined start time may be a time at which the VSLAM device 205 was most recently initialized. The predetermined start time may be a time at which the VSLAM device 205 most recently received an instruction to begin a VSLAM procedure. The predetermined start time may be a time at which the VSLAM device 205 most recently determined that it entered a new room, or a new region of an environment.

If the feature tracking engine 225 fails to successfully perform feature tracking on an image, the VSLAM system 270 can perform relocalization using a relocalization engine 230. The relocalization engine 230 attempts to determine where in the environment the VSLAM device 205 is located. For instance, the feature tracking engine 225 can fail to recognize any features from one or more previously-captured image and/or from the local map 250. The relocalization engine 230 can attempt to see if any features recognized by the feature extraction engine 220 match any features in the global map. If one or more features that the VSLAM system 270 identified by the feature extraction engine 220 match one or more features in the global map 255, the relocalization engine 230 successfully performs relocalization by determining the map points 240 for the one or more features and/or determining the pose 245 of the VSLAM device 205. The relocalization engine 230 may also compare any features identified in the image 215 by the feature extraction engine 220 to features in keyframes stored alongside the local map and/or the global map. Each keyframe may be an image that depicts a particular feature clearly, so that the image 230 can be compared to the keyframe to determine whether the image 230 also depicts that particular feature. If none of the features that the VSLAM system 270 identifies during feature extraction 220 match any of the features in the global map and/or in any keyframe, the relocalization engine 230 fails to successfully perform relocalization. If the relocalization engine 230 fails to successfully perform relocalization, the VSLAM system 270 may exit and reinitialize the VSLAM process. Exiting and reinitializing may include generating the local map 250 and/or the global map 255 from scratch.

The VSLAM device 205 may include a conveyance through which the VSLAM device 205 may move itself about the environment. For instance, the VSLAM device 205 may include one or more motors, one or more actuators, one or more wheels, one or more propellers, one or more turbines, one or more rotors, one or more wings, one or more airfoils, one or more gliders, one or more treads, one or more legs, one or more feet, one or more pistons, one or more nozzles, one or more thrusters, one or more sails, one or more other modes of conveyance discussed herein, or combinations thereof. In some examples, the VSLAM device 205 may be a vehicle, a robot, or any other type of device discussed herein. A VSLAM device 205 that includes a conveyance may perform path planning using a path planning engine 260 to plan a path for the VSLAM device 205 to move. Once the path planning engine 260 plans a path for the VSLAM device 205, the VSLAM device 205 may perform movement actuation using a movement actuator 265 to actuate the conveyance and move the VSLAM device 205 along the path planned by the path planning engine 260. In some examples, path planning engine 260 may use a Dijkstra algorithm to plan the path. In some examples, the path planning engine 260 may include stationary obstacle avoidance and/or moving obstacle avoidance in planning the path. In some examples, the path planning engine 260 may include determinations as to how to best move from a first pose to a second pose in planning the path. In some examples, the path planning engine 260 may plan a path that is optimized to reach and observe every portion of every room before moving on to other rooms in planning the path. In some examples, the path planning engine 260 may plan a path that is optimized to reach and observe every room in an environment as quickly as possible. In some examples, the path planning engine 260 may plan a path that returns to a previously-observed room to observe a particular feature again to improve one or more map points corresponding the feature in the local map and/or global map. In some examples, the path planning engine 260 may plan a path that returns to a previously-observed room to observe a portion of the previously-observed room that lacks map points in the local map and/or global map to see if any features can be observed in that portion of the room.

While the various elements of the conceptual diagram 200 are illustrated separately from the VSLAM device 205, it should be understood that the VSLAM device 205 may include any combination of the elements of the conceptual diagram 200. For instance, at least a subset of the VSLAM system 270 may be part of the VSLAM device 205. At least a subset of the mapping system 275 may be part of the VSLAM device 205. For instance, the VSLAM device 205 may include the camera 210, feature extraction engine 220, the feature tracking engine 225, the relocation engine 230, the map optimization engine 235, the local mapping engine 250, the global mapping engine 255, the map merging engine 257, the path planning engine 260, the movement actuator 265, or some combination thereof. In some examples, the VSLAM device 205 can capture the image 215, identify features in the image 215 through the feature extraction engine 220, track the features through the feature tracking engine 225, optimize the map using the map optimization engine 235, perform relocalization using the relocalization engine 230, determine map points 240, determine a device pose 245, generate a local map using the local mapping engine 250, update the local map using the local mapping engine 250, perform map merging using the map merging engine 257, generate the global map using the global mapping engine 255, update the global map using the global mapping engine 255, plan a path using the path planning engine 260, actuate movement using the movement actuator 265, or some combination thereof. In some examples, the feature extraction engine 220 and/or the feature tracking engine 225 are part of a front-end of the VSLAM device 205. In some examples, the relocalization engine 230 and/or the map optimization engine 235 are part of a back-end of the VSLAM device 205. Based on the image 215 and/or previous images, the VSLAM device 205 may identify features through feature extraction 220, track the features through feature tracking 225, perform map optimization 235, perform relocalization 230, determine map points 240, determine pose 245, generate a local map 250, update the local map 250, perform map merging, generate the global map 255, update the global map 255, perform path planning 260, or some combination thereof.

In some examples, the map points 240, the device poses 245, the local map, the global map, the path planned by the path planning engine 260, or combinations thereof are stored at the VSLAM device 205. In some examples, the map points 240, the device poses 245, the local map, the global map, the path planned by the path planning engine 260, or combinations thereof are stored remotely from the VSLAM device 205 (e.g., on a remote server), but are accessible by the VSLAM device 205 through a network connection. The mapping system 275 may be part of the VSLAM device 205 and/or the VSLAM system 270. The mapping system 275 may be part of a device (e.g., a remote server) that is remote from the VSLAM device 205 but in communication with the VSLAM device 205.

In some cases, the VSLAM device 205 may be in communication with a remote server. The remote server can include at least a subset of the VSLAM system 270. The remote server can include at least a subset of the mapping system 275. For instance, the VSLAM device 205 may include the camera 210, feature extraction engine 220, the feature tracking engine 225, the relocation engine 230, the map optimization engine 235, the local mapping engine 250, the global mapping engine 255, the map merging engine 257, the path planning engine 260, the movement actuator 255, or some combination thereof. In some examples, the VSLAM device 205 can capture the image 215 and send the image 215 to the remote server. Based on the image 215 and/or previous images, the remote server may identify features through the feature extraction engine 220, track the features through the feature tracking engine 225, optimize the map using the map optimization engine 235, perform relocalization using the relocalization engine 230, determine map points 240, determine a device pose 245, generate a local map using the local mapping engine 250, update the local map using the local mapping engine 250, perform map merging using the map merging engine 257, generate the global map using the global mapping engine 255, update the global map using the global mapping engine 255, plan a path using the path planning engine 260, or some combination thereof. The remote server can send the results of these processes back to the VSLAM device 205.

The accuracy of tracking features for VSLAM and other localization techniques is based on the identification of features that are closer to the device. For example, a device may be able to identify features of a statue that is 4 meters away from the device but is unable to identify distinguishing features when the statue is 20 meters away from the device. The lighting of the environment can also affect the tracking accuracy of a device that uses VSLAM and localization techniques.

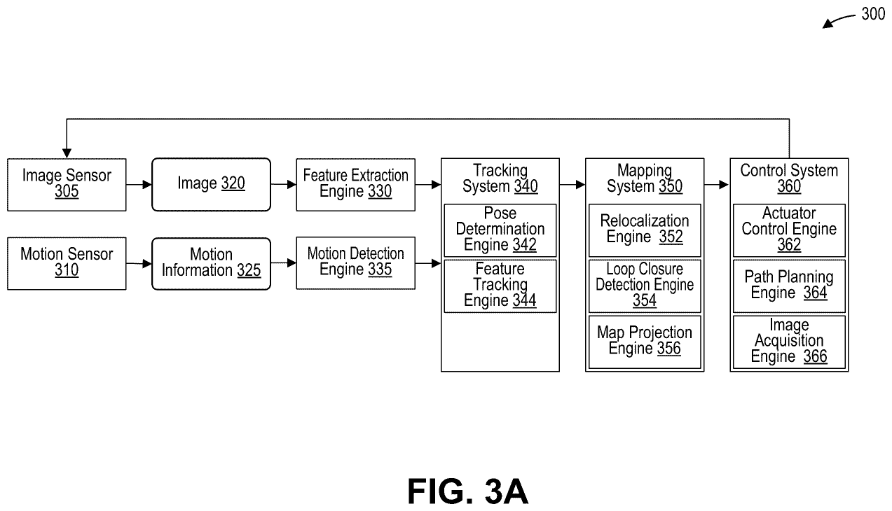

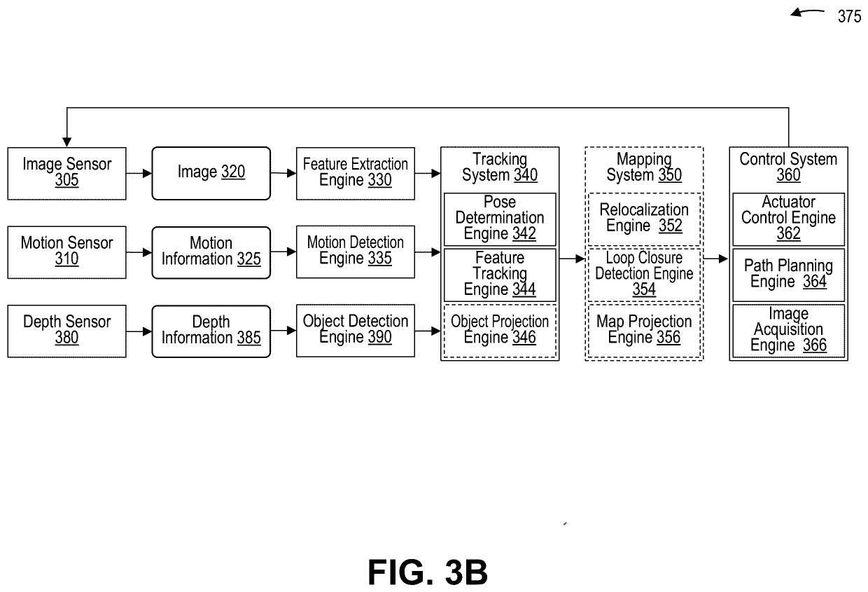

FIG. 3A is a conceptual diagram of a device 300 for capturing images based on localization and mapping techniques in consideration of the lighting conditions of an environment. In some aspects, the device 300 can perform VSLAM techniques to determine the positions of the device 300 within the environment. The device 300 of FIG. 3A may be any type of VSLAM device, including any of the types of VSLAM device discussed with respect to the VSLAM device 205 of FIG. 2. In other aspects, the device 300 may locally (e.g., on the device 300) or remotely (e.g., through a service, such as a micro-service) access an existing map. For example, the device can be configured to perform functions within an existing area based on a known map. An example of a localization device is an autonomous bus service that services a campus using a known map that is stored within the bus or is made available to the bus using wireless communication.

The device 300 includes an image sensor 305 and a motion sensor 310. The image sensor 305 is configured to generate an image 320 on a periodic or aperiodic basis and provide the image to a feature extraction engine 330 configured to identify various features in the environment. The features may be known to the feature extraction engine 330 (e.g., because of a map) or may be unknown (e.g., a person in the environment). The feature extraction engine 330 extracts and provides information related to the identified features to a tracking system.

In some cases, the motion sensor 310 may be an inertia measurement unit (IMU), an accelerometer, or other device that is capable of motion information 325. The motion information 325 can be relative or absolute position, and is provided to a motion detection engine 335 to identify motion within the environment. The motion detection engine 335 is configured to receive the raw sensor data and process the sensor data to identify movement, rotation, position, orientation, and other relevant information that is provided

In some aspects, the tracking system 340 is configured to use the image 320 and the motion information provided from the motion detection engine 335 to determine pose information associated with the device. For example, the pose information can include a position (e.g., a position on a map) and a location of the device 300 relative to any information. For example, the device 300 can be an autonomous bus that uses localization to identify a fixed route and navigate that fixed route. The device 300 may also be an autonomous ground device, such as an autonomous vacuum cleaner, that uses VSLAM techniques to create a map of the environment and navigate within the environment.

In some aspects, the device 300 may use the image sensor 305 to capture images and use mapping information to determine exposure control information to facilitate object identification. For example, if an average luminance associated with a region in an image 320 captured by the image sensor 305 has less than a predetermined luminance threshold, the device 300 may determine that the region is poorly illuminated and be unable to identify features within that region. In some cases, the poorly illuminated region may be close to the device, and well-illuminated region of the image 320 may be far away. In this example, the device 300 may be unable to identify features in the well-illuminated region based on the distance between the device 300 and the well-illuminated region. For example, if the device 300 is 30 meters away from a fixed statue, the device 300 may be unable to identify features of the fixed statue based on the distance and distance can cause the device 300 to create errors while performing localization or SLAM techniques. In this case, localization indicates that the device 300 is not performing any mapping functions and is relying on a known map to navigate the environment (e.g., a ground truth), and SLAM indicates that the device is navigating the region without a ground truth based on generating a local map using an existing map or a generated map.

The device 300 may move throughout an environment, reaching multiple positions along a path through the environment. A tracking system 340 is configured to receive the features extracted from the feature extraction engine 330 and the motion information from the motion detection engine 335 to determine pose information of the device 300. For example, the pose information can determine a position of the device 300, an orientation of the device, and other relevant information that will allow the device 300 to use localization or SLAM techniques.

In some aspects, the tracking system 340 includes a device pose determination engine 342 may determine a pose of the device 300. The device pose determination engine 370 may be part of the device 300 and/or the remote server. The pose of the device 300 may be determined based on the feature extraction by the feature extraction engine 330, the determination of map points and updates to the map by the mapping system 350, or some combination thereof. In other aspects, the device 300 can include other sensors such as a depth sensor, such as the device 375 illustrated in FIG. 3B, and the features detected by other sensors can be used to determine the pose information of the device 300. The pose of the device 300 may refer to the location of the device 300 and/or an orientation of the device 300 (e.g., represented as a pitch roll, and yaw of the device 300, a quaternion, SE3, DCM, or any combination thereof). The pose of the device 300 may refer to the pose of the image sensor 305, and may thus include the location of the image sensor 305 and/or the orientation of the image sensor 305. The pose of the device 300 can also refer to the orientation of the device, a position of the device, or some combination thereof.

The tracking system 340 may include a device pose determination engine 342 to determine the pose of the device 300 with respect to the map, in some cases using the mapping system 350. The device pose determination engine 342 may mark the pose of the device 300 on the map, in some cases using the mapping system 350. In some cases, the device pose determination engine 342 may determine and store a history of poses within the map or otherwise. The history of poses may represent a path of the device 300. The device pose determination engine 342 may further perform any procedures discussed with respect to the determination of the pose 245 of the VSLAM device 205 of the conceptual diagram 200. In some cases, the device pose determination engine 342 may determining the pose of the device 300 by determining a pose of a body of the device 300, determining a pose of the image sensor 305, determining a pose of another sensor such as a depth sensor, or some combination thereof. One or more of the poses may be separate outputs of the tracking system 340. The device pose determination engine 342 may in some cases merge or combine two or more of those three poses into a single output of the tracking system 340, for example by averaging pose values corresponding to two or more of those three poses.

The tracking system 340 may include a feature tracking engine 344 and identifies features within the image 320. The feature tracking engine 344 can perform feature tracking by recognizing features in the image 320 that were already previously recognized in one or more previous images, or from features that are identified by the mapping system 350. For example, based on the pose information of the device 300, the mapping system 350 may provide information that predicts locations of features within the image 320. The feature tracking engine 344 can also track changes in one or more positions of the features between the different images. For example, the feature extraction engine 330 can detect a lane marker in a first image. The feature extraction engine 330 can detect the same feature (e.g., the same lane marker) depicted in a second image captured by and received from the image sensor 305 after the first image. The feature tracking engine 344 can recognize that these features detected in the first image and the second image are two depictions of the same feature (e.g., the lane marker). The feature tracking engine 344 can recognize that the feature has moved between the first image and the second image. For instance, the feature tracking engine 344 can recognize that the feature is depicted on the right-hand side of the first image, and is depicted in the center of the second image

In some aspects, the device 300 may include a mapping system 350 that is configured to perform VSLAM or other localization techniques. The mapping system 350 can include a stored map, such as a 3D point cloud, that identifies various objects that are known within the environment. A 3D point cloud is a data structure that comprises mathematical relationships and other information such as annotations (e.g., labels that describe a feature), voxels, images, and form a map that is usable by the mapping system 350 to identify a position. In some aspects, while the 3D point cloud is described as an example of a map, the 3D point cloud is a complex data structure that is usable by a computing device (e.g., by the device 300) to use math, logic functions, and machine learning (ML) techniques to ascertain a position and features within the environment of the device 300. In some examples, a 3D point cloud can consist of millions of data points that identify various points in space that the device 300 can use for localization and navigation. In some aspects, the mapping system 350 may be configured to predict the position of the device 300 for a number of frames based on the pose and position of the device 300. The device 300 can various information such as velocity, acceleration, and so forth to determine a position over a time period (e.g., 333 ms or 10 frames if the device 300 has an internal processing rate of 30 frames per second (FPS)). The mapping system 350 can also identify mapping information that includes features within the map (e.g., the 3D point cloud) that the device 300 is able to perceive based on the pose information. A 3D point cloud is an example of map information that the device 300 may use and other types of map information may be used.

In some aspects, the mapping system 350 can at least partially use a cloud computing function and offload calculations to another device. For example, an autonomous vehicle can provide extracted information (e.g., an image processed for edge detection, a 3D point cloud processed for edge detection, etc.) to another device for mapping functions. In this aspect, the device 300 can provide pose information to an external system and receive a predicted position of the device 300 for a number of frames. In other aspects, the mapping system 350 may store a 3D point cloud that is mapped by other devices (e.g., other autonomous vehicles) and annotated with features (e.g., road signs, vegetation, etc.) by human and machine labelers (e.g., an AI-based software that trained to identify various features within the 3D point cloud).

In some aspects, the mapping system 350 can generate the map of the environment based on the sets of coordinates that the device 300 determines for all map points for all detected and/or tracked features, including features extracted by the feature extraction engine 330. In some cases, when the mapping system 350 first generates the map, the map can start as a map of a small portion of the environment. The mapping system 350 may expand the map to map a larger and larger portion of the environment as more features are detected from more images, and as more of the features are converted into map points that the mapping system 350 updates the map to include. The map can be sparse or semi-dense. In some cases, selection criteria used by the mapping system 340 for map points corresponding to features can be harsh to support robust tracking of features using the feature tracking engine 330.

In some aspects, the mapping system 350 may include a relocalization engine 352 (e.g., relocalization engine 230) to determine the location of the device 300 within the map. For instance, the relocalization engine may relocate the device 300 within the map if the tracking system 340 fails to recognize any features in the image 320 or features identified in previous images. The relocalization engine 352 can determine the location of the device 300 within the map by matching features identified in the image 320 and the feature extraction engine 330 with features corresponding to map points in the map, or some combination thereof. The relocalization engine 352 may be part of the device 300 and/or a remote server. The relocalization engine 352 may further perform any procedures discussed with respect to the relocalization engine 230 of the conceptual diagram 200.

The loop closure detection engine 354 may be part of the device 300 and/or the remote server. The loop closure detection engine 354 may identify when the device 300 has completed travel along a path shaped like a closed loop or another closed shape without any gaps or openings. For instance, the loop closure detection engine 354 can identify that at least some of the features depicted in and detected in the image 320 match features recognized earlier during travel along a path on which the device 300 is traveling. The loop closure detection engine 354 may detect loop closure based on the map as generated and updated by the mapping system 350 and based on the pose determined by the device pose determination engine 342. Loop closure detection by the loop closure detection engine 354 prevents the feature tracking engine 344 from incorrectly treating certain features depicted in and detected in the image 320 as new features when those features match features previously detected in the same location and/or area earlier during travel along the path along which the device 300 has been traveling.

The mapping system 350 may also include a map projection engine 356 configured to identify features within the environment based on the map. For example, based on the mapping information and the pose information, the control system 360 is configured to map features into a data structure that corresponds to the image 320. For example, the control system 360 can mathematically convert the 3D data associated with the map (e.g., the 3D point cloud) and project the features into a two-dimensional (2D) coordinate space such as a 2D map that corresponds to the image 320. In one aspect, the map projection engine 356 can create a data structure that identifies features that can be identified in the image 320 based on the pose. This feature allows the features within the 2D image to be correlated with the map to perform a high-fidelity tracking of the device 300 in the environment. In another example, the control system can generate a 2D array (e.g., a bitmap) with values that identify a feature associated with the map and can be used to identify and track features in the image 320.

A control system 360 is configured to receive the predicted position of the device 300. Although not illustrated, the control system 360 can also receive other information, such as the features extracted by the feature extraction engine 330, the pose information, and the image 320. In one illustrative aspect, the control system 360 includes an actuator control engine 362 that is configured to control various actuators (not shown) of the device 300 to cause the device 300 to move within the environment. The control system 360 may also include a path planning engine 364 to plan a path that the device 300 is to travel along using the conveyance. The path planning engine 364 can plan the path based on the map, based on the pose of the device 300, based on relocalization by the relocalization engine 352, and/or based on loop closure detection by the loop closure detection engine 354. The path planning engine 364 can be part of the device 300 and/or the remote server. The path planning engine 364 may further perform any procedures discussed with respect to the path planning engine 260 of the conceptual diagram 200.

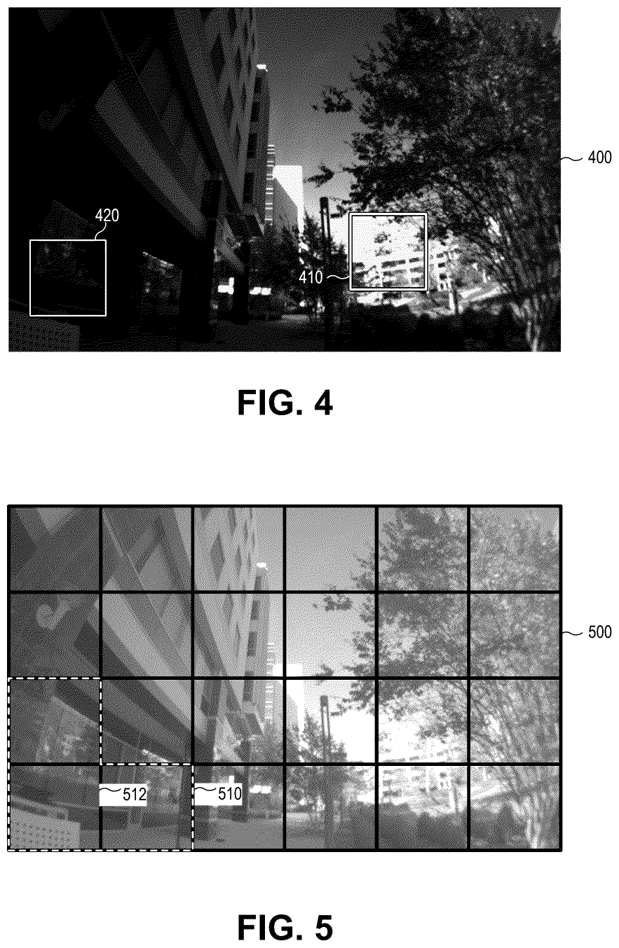

In some aspects, the features within the image 320 are not consistently illuminated. For example, a bench along a path of an autonomous bus will have different illumination based on the time of year, the time of day, and the surrounding environment (e.g., buildings, vegetation, lighting, etc.). In this case, the bench may be in a poorly illuminated environment due to a position of the sun while other objects far away are bright. The device 300 may be positioned within this dark poorly illuminated environment and features for the device 300 to track can be positioned at a large distance, which the device 300 may not accurately track based on distance to the features. An example of a poorly illuminated environment is illustrated herein with reference to FIG. 4.

In some aspects, the control system 360 can include an image acquisition engine 366 that is configured to control the image sensor 305 to optimize images 320. For example, the image acquisition engine 366 may determine that the foreground region 420 in FIG. 4 includes a number of features for SLAM and localization techniques, but features that in the image 320 are underexposed (e.g., too dark). In this case, based on the underexposure of features in the image 320 that are near the device 300, the feature extraction engine 330 may not identify the features in the image 320.

In some cases, the image acquisition engine 366 may be configured to control an exposure based on the features that are predicted to be positioned within the image 320. In one illustrative aspect, the image acquisition engine 366 identifies relevant features that are in the image 320 based on the pose information and the mapping information. For example, the image acquisition engine 366 can receive the 2D map from the map projection engine 356 that corresponds to the image 320. The image acquisition engine 366 may identify features within the image 320 for tracking based on a number of features and depths of the features (corresponding to a distance of the features within an image from the image sensor 305). The image acquisition engine 366 can determine that the image 320 is underexposed for feature tracking.

As a result of underexposure for some regions of the image 320, the feature extraction engine 330 may not be able to accurately identify features. In some aspects, the image acquisition engine 366 is configured to analyze the image and control the image sensor 305 to capture images. For example, the image acquisition engine 366 can control a gain of the image sensor 305 and/or can control an exposure time of the image sensor 305. Controlling the gain and/or the exposure time can increase the brightness, e.g., the luma, of the image. After controlling the gain and/or exposure time, the feature extraction engine 330 may be able to identify and extract the features and provide the features to the tracking system 340 for tracking.

Although the device 300 is described as using localization techniques for autonomous navigation, the device 300 may also be a device capable of movement in 6 degrees of freedom (6DOF). In some aspects, 6DOF refers to the freedom of movement of a rigid body in three-dimensional space by translation and rotation in a 3D coordinate system. For example, the device 300 may be moved by a user along the path, rotated along a path, or a combination of movement and rotation. For instance, the device 300 may be moved by a user along the path if the device 300 is a head-mounted display (HMD) (e.g., XR headset) worn by the user. In some cases, the environment may be a virtual environment or a partially virtual environment that is at least partially rendered by the device 300. For instance, if the device 300 is an AR, VR, or XR headset, at least a portion of the environment may be virtual.

The device 300 can use the map to perform various functions with respect to positions depicted or defined in the map. For instance, using a robot as an example of a device 300 utilizing the techniques described herein, the robot can actuate a motor to move the robot from a first position to a second position. The second position can be determined using the map of the environment, for instance, to ensure that the robot avoids running into walls or other obstacles whose positions are already identified on the map or to avoid unintentionally revisiting positions that the robot has already visited. A device 300 can, in some cases, plan to revisit positions that the device 300 has already visited. For instance, the device 300 may revisit previous positions to verify prior measurements, to correct for drift in measurements after a closing a looped path or otherwise reaching the end of a long path, to improve accuracy of map points that seem inaccurate (e.g., outliers) or have low weights or confidence values, to detect more features in an area that includes few and/or sparse map points, or some combination thereof. The device 300 can actuate the motor to move from the initial position to a target position to achieve an objective, such as food delivery, package delivery, package retrieval, capturing image data, mapping the environment, finding and/or reaching a charging station or power outlet, finding and/or reaching a base station, finding and/or reaching an exit from the environment, finding and/or reaching an entrance to the environment or another environment, or some combination thereof.

In another illustrative aspect, the device 300 may be used to track and plan the movement of the device 300 within the environment. For example, an autonomous vehicle may use features extracted from an image sensor (e.g., image sensor 305) and other sensors to navigate on a road. A feature that may be in a poorly lit environment that the autonomous vehicle tracks is a lane marker which can be used by the autonomous vehicle to prevent collisions, change lanes when appropriate, and so forth. When a lane marker that is proximate to the autonomous vehicle is located within a poorly illuminate d environment and other lane markers at a longer distance from the autonomous vehicle are in a highly illuminated environment, the autonomous vehicle may not accurately identify the lane marker and may incorrectly identify a position and/or a pose of the autonomous vehicle. In some aspects, the image acquisition engine 366 can be configured to control the image sensor 305 based on objects that are closer to the autonomous vehicle to improve tracking and localization functions.

In one illustrative aspect, the image acquisition engine 366 is configured to identify different regions of the image 320 by dividing the image 320 into a grid and analyzing features from each bin. In some aspects, the features of the bin may be detected from the image 320 or may be determined based on the 2D map generated by the 356. FIG. 5 illustrates an example illustration of a grid that the image acquisition engine 366 is configured to generate based on dividing the image 320 into a 4×6 grid of bins (or cells). The image acquisition engine 366 may be configured to determine an average luma associated with pixels in each bin. The image acquisition engine 366 may also determine a number of features in each bin based on the image 320. In another illustrative example, the image acquisition engine 366 may also determine the number of features in each bin based on the 2D map generated by the map projection engine 356 because the features may not be adequately identified based on the underexposure of the image 320. The image acquisition engine 366 may also determine the distance to objects, or the depths of features of the objects, within each bin.

The image acquisition engine 366 is further configured to select a representative bin based on the depths of the features of the objects and the number of features in that bin. As noted above, tracking of features for localization may be more accurate for closer features (e.g., features with lower depths) and the image acquisition engine 366 may identify candidate bins that have a maximum number of features (e.g., 2) and features at minimum depths with respect to the image sensor or camera (corresponding to a distance from the image sensor or camera). In other examples, the representative bin can be selected from the candidate bins based on the depths of the features because tracking accuracy is correlated to distance from the image sensor or camera to the objects (the depths of the features), where higher tracking accuracy can be achieved based on nearby objects or features.

FIG. 3B is a conceptual diagram of a device 375 for capturing images based on localization and mapping techniques in consideration of the lighting conditions of an environment. The device 375 includes the image sensor 305, the motion sensor 310, the feature extraction engine 330, the motion detection engine 335, the tracking system 340, and a local mapping system 350, and the control system 360. The device 375 further includes a depth sensor 380 configured to generate depth information 385 and an object detection engine 390 configured to detect objects within the depth information 385.

In some aspects, the depth sensor 380 is configured to provide distance information regarding objects within the environment. Illustrative examples of a depth sensor include a light detection and ranging (LiDAR) sensor, a radar, and a time of flight (ToF) sensor. The depth information 385 is provided to the mapping system 350 to perform the identification of various objects within the environment based on segmentation, edge detection, and other recognition techniques. For example, the mapping system 350 can identify edges associated with a hard structure, lane markers based on different reflections from signals associated with the loop closure detection engine 354, and other environmental features.

The tracking system 340 can use the object information detected by the mapping system 350 to perform the various functions described above in conjunction or separately from the feature extraction engine 330. In one aspect, the mapping system 350 may be able to identify features that are more distinguishable from the image 320, and the feature tracking engine 344 can use the depth information 385 to track the feature in either the image 320 or the depth information 385. For example, a pole or a sign may be easier to identify in the depth information 385 because the objects behind the road sign are at a greater distance. In some illustrative aspects, the mapping system 350 may use the depth information 385 to create and populate a map based on depth information 385 and continue to update the map based on the depth information 385. The mapping system 350 may also be configured to combine the images 320 with the depth information 385 to identify changes within the environment.

In other aspects, the device 375 may omit the mapping system 350 and use an extrinsic calibration engine to navigate the environment without mapping information and the extrinsic calibration engine and objects detected by the mapping system 350 can be used by the tracking system 340 to control image acquisition. The tracking system 340 can include an object projection engine 346 to project objects detected by the mapping system 350 into a 2D map that corresponds to the image 320. For example, the loop closure detection engine 354 can be located on a different surface of the device 300 and have a different orientation than the image sensor 305, and the features in the image 320 and the extrinsic calibration engine do not align. In one aspect, the features detected by the mapping system 350 are in a 3D coordinate space and may be projected into a 2D map that corresponds to the image 320. The feature tracking engine 344 can use the 2D map to track features in the extrinsic calibration engine and the image 320. In one illustrative aspect, the image acquisition engine 366 may compare features identified by the mapping system 350 within the 2D map to a corresponding region in the image 320 and control the image sensor 305 based on the brightness of the region in the image 320. For example, the loop closure detection engine 354 operates by projecting a signal (e.g., electromagnetic energy) and receiving that signal and can perceive the features irrespective of illumination, and the brightness of the image 320 is correlated to the illumination. The image acquisition engine 366 can determine that the image 320 is underexposed based on the brightness.

FIG. 4 is an example image 400 that illustrates a poorly lit environment due to the image capturing device being shaded by a building based on the position of the sun, and the background of a background region 410 is sufficiently lit. The background region 410 is far away and may not be usable for SLAM and localization techniques. A foreground region 420 includes features that can be used for tracking, but are underexposed due to the shade provided by the building.

FIG. 5 is an example image 500 that illustrates generated by a device configured to control an image sensor based on localization in accordance with some aspects of the disclosure. For example, the image acquisition engine 366 may control image sensor 305 to capture the example image 500 based on generating a grid of bins and determining an exposure control based on features within a representative bin selected from a plurality of candidate bins 510. The example image 500 corresponds to the image 400 in FIG. 4 and is enhanced to improve object detection within a first bin 512. For example, the image acquisition engine 366 can identify the candidate bins 510 and then select the first bin 512 as being representative based on a combination of the depths of the features within the first bin 512 and the number of features within the first bin 512. For example, a number of features from the candidate bins 510 can have distinct edges that can be tracked by the feature tracking engine 344, and the first bin 512 can be selected based on the depth of the features and the number of features within the first bin 512. However, as illustrated in FIG. 4, the corresponding area is underexposed and features may not be accurately identified during feature extraction (e.g., by the feature extraction engine 330). In one aspect, the image acquisition engine 366 is configured to increase the exposure time of the image sensor 305 to create the example image 500 and increase the luma associated with the first bin 510. For example, the image acquisition engine 366 can determine an exposure time based on an average luma of the first bin 510 (e.g., the representative bin) in a previous image.

By increasing the exposure time, the features of the example image 500 can be identified by a device (e.g., by the feature extraction engine 330 of the device 300) to improve the identification and tracking of features that are closer to the device.

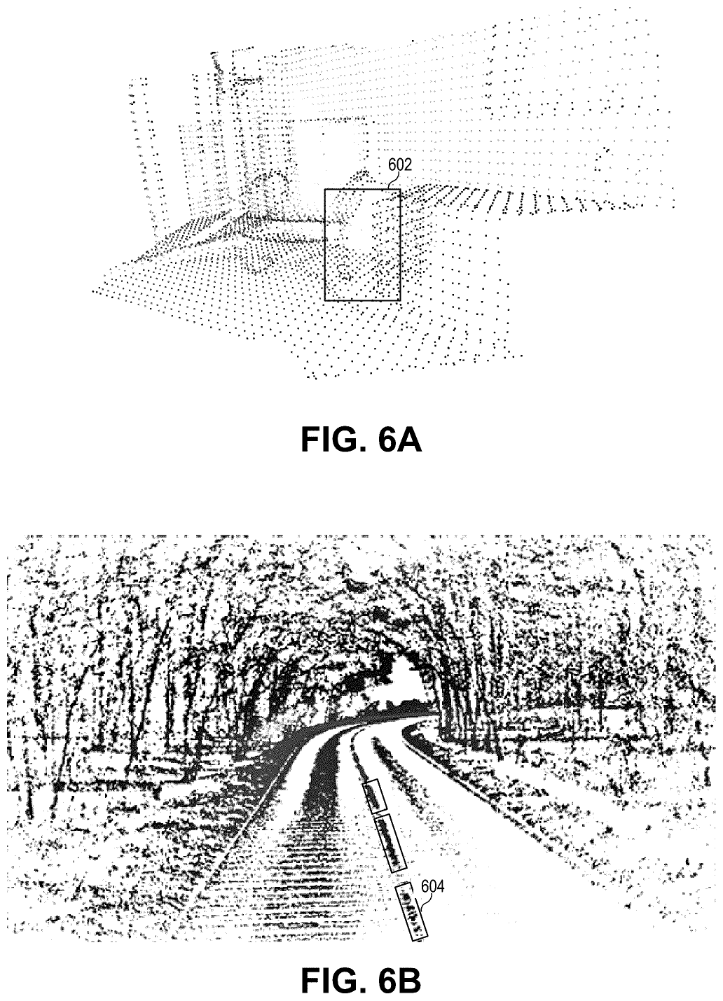

FIG. 6A illustrates an example of a visualization of a 3D point cloud by a computing device that identifies a region of interest in accordance with some aspects of the disclosure. In particular, the 3D point cloud illustrated in FIG. 6A is a visualization by a computing device (e.g., computing system 1000) that is required for a person to understand. In some aspects, the 3D point cloud is generated by a depth sensor such as a LiDAR sensor, and the points each corresponds to a numerical distance. A region 602 can is identified as a region of interest because of the edges of an object within FIG. 6A can be identified based on a comparison to nearby points in the point cloud. In some aspects, a device that uses a localization and VSLAM techniques can identify the region 602 based on a number of features and depths of features of the region 602. Based on the region 602, the device may control an image sensor (e.g., the image sensor 305) to capture the region 602 with an exposure time to ensure that the average luma of an image (e.g., the image 320) has sufficient brightness for object detection (e.g., by the mapping system 350) and feature extraction (e.g., by the feature extraction engine 330).

FIG. 6B illustrates an example of a visualization of a 3D point cloud by a computing device that identifies a region of interest in accordance with some aspects of the disclosure. In particular, the 3D point cloud illustrated in FIG. 6B is a visualization by a computing device (e.g., computing system 1000) that is required for a person to understand. In some aspects, the 3D point cloud is generated by a depth sensor such as a LiDAR sensor and each point corresponds to a numerical distance. A region 604 can is identified as a region of interest because of the edges of an object within FIG. 6B corresponds to a particular shape of interest. For example, the region 604 can correspond to a lane marker based on the density of points and a pattern that corresponds to a lane marker. In some aspects, a device that uses a localization or VSLAM techniques can identify the region 604 and control an image sensor (e.g., the image sensor 305) to capture the region 604 with an exposure time to ensure that the average luma of an image (e.g., the image 320) has sufficient brightness for object detection (e.g., by the mapping system 350) and feature extraction (e.g., by the feature extraction engine 330).

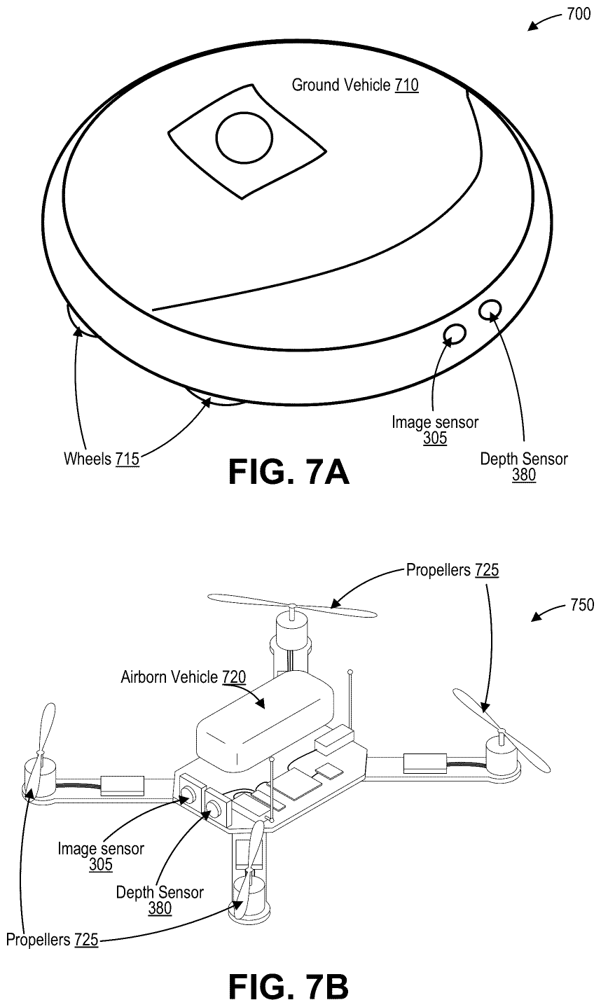

FIG. 7A is a perspective diagram 700 illustrating an unmanned ground vehicle 710 that performs visual simultaneous localization and mapping (VSLAM). The ground vehicle 710 illustrated in the perspective diagram 700 of FIG. 7A may be an example of a VSLAM device 205 that performs the VSLAM technique illustrated in the conceptual diagram 200 of FIG. 2, a device 300 that performs a localization or other VSLAM technique illustrated in the conceptual diagram 300 of FIG. 3A, and/or a device 375 that performs the localization technique illustrated in FIG. 3B. The ground vehicle 710 includes an image sensor 305 along the front surface of the ground vehicle 710. The ground vehicle 710 may also include a depth sensor 380. The ground vehicle 710 includes multiple wheels 715 along the bottom surface of the ground vehicle 710. The wheels 715 may act as a conveyance of the ground vehicle 710 and may be motorized using one or more motors. The motors, and thus the wheels 715, may be actuated to move the ground vehicle 710 via the movement actuator 265.

FIG. 7B is a perspective diagram 750 illustrating an airborn (or aerial) vehicle 720 that performs VSLAM or other localization techniques. The airborn vehicle 720 illustrated in the perspective diagram 750 of FIG. 7B may be an example of a VSLAM device 205 that performs the VSLAM technique illustrated in the conceptual diagram 200 of FIG. 2, a device 300 that performs the VSLAM or localization technique illustrated in the conceptual diagram 300 of FIG. 3A, and/or a device 375 that performs the localization technique illustrated in FIG. 3B. The airborn vehicle 720 includes a image sensor 305 along a front portion of a body of the ground vehicle 710. The airborn vehicle 720 may also include a depth sensor 380. The airborn vehicle 720 includes multiple propellers 725 along the top of the airborn vehicle 720. The propellers 725 may be spaced apart from the body of the airborn vehicle 720 by one or more appendages to prevent the propellers 725 from snagging on circuitry on the body of the airborn vehicle 720 and/or to prevent the propellers 725 from occluding the view of the image sensor 305 and depth sensor 380. The propellers 725 may act as a conveyance of the airborn vehicle 720 and may be motorized using one or more motors. The motors, and thus the propellers 725, may be actuated to move the airborn vehicle 720 via the movement actuator 265.

In some cases, the propellers 725 of the airborn vehicle 720, or another portion of a VSLAM device 205, device 300, or device 375 (e.g., an antenna), may partially occlude the view of the image sensor 305 and depth sensor 380. In some examples, this partial occlusion may be edited out of any images and/or IR images in which it appears before feature extraction is performed. In some examples, this partial occlusion is not edited out of VL images and/or IR images in which it appears before feature extraction is performed, but the VSLAM algorithm is configured to ignore the partial occlusion for the purposes of feature extraction, and therefore do not treat any part of the partial occlusion as a feature of the environment.

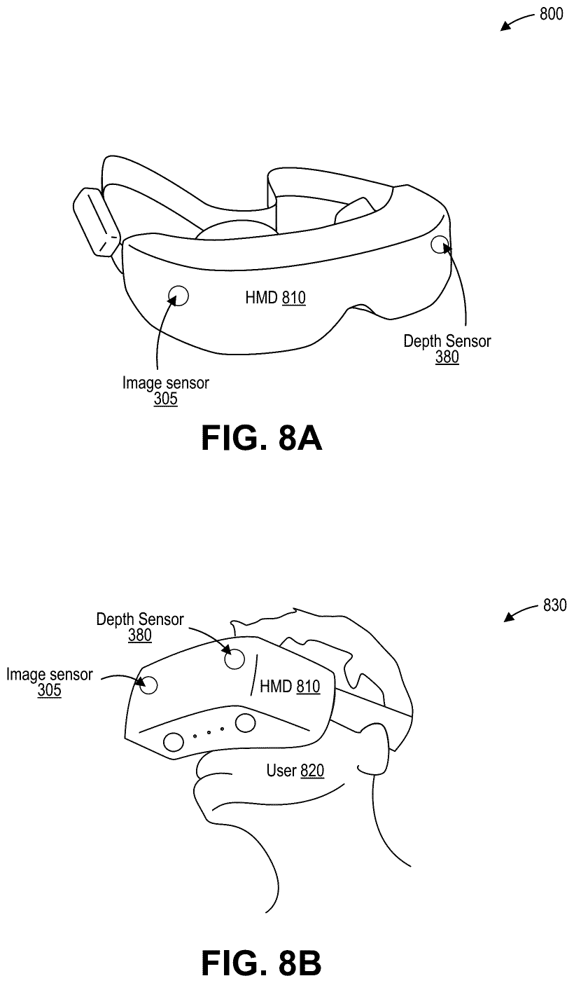

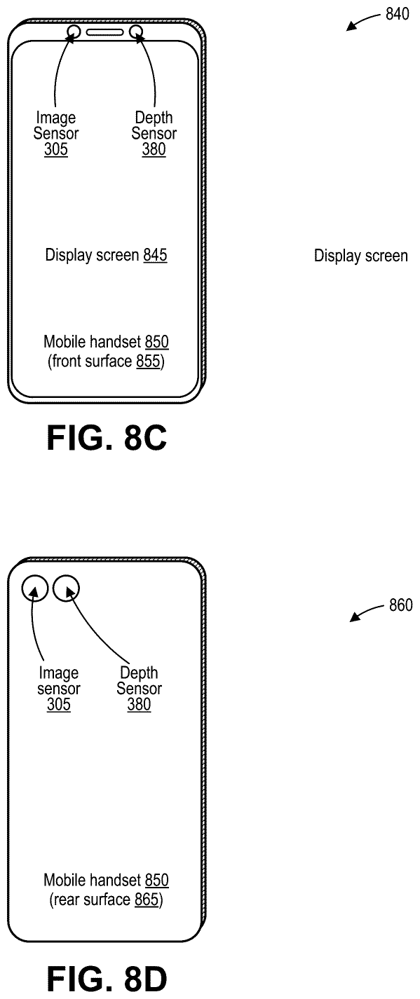

FIG. 8A is a perspective diagram 800 illustrating a head-mounted display (HMD) 810 that performs visual simultaneous localization and mapping (VSLAM). The HMD 810 may be an XR headset. The HMD 810 illustrated in the perspective diagram 800 of FIG. 8A may be an example of a VSLAM device 205 that performs the VSLAM technique illustrated in the conceptual diagram 200 of FIG. 2, a device 300 that performs the VSLAM technique or other localization technique illustrated in the conceptual diagram 300 of FIG. 3A, and/or a device 375 that performs the localization technique illustrated in FIG. 3B. The HMD 810 includes a image sensor 305 and depth sensor 380 along a front portion of the HMD 810. The HMD 810 may be, for example, an augmented reality (AR) headset, a virtual reality (VR) headset, a mixed reality (MR) headset, or some combination thereof.

FIG. 8B is a perspective diagram 830 illustrating the head-mounted display (HMD) of FIG. 8A being worn by a user 820. The user 820 wears the HMD 810 on the user 820's head over the user 820's eyes. The HMD 810 can capture VL images with the image sensor 305 and depth sensor 380. In some examples, the HMD 810 displays one or more images to the user 820's eyes that are based on the VL images and/or the IR images. For instance, the HMD 810 may provide overlaid information over a view of the environment to the user 820. In some examples, the HMD 810 may generate two images to display to the user 820—one image to display to the user 820's left eye, and one image to display to the user 820's right eye. While the HMD 810 is illustrated as having only one image sensor 305 and depth sensor 380, in some cases the HMD 810 (or any other VSLAM device 205 or device 300) may have more than one image sensor 305. For instance, in some examples, the HMD 810 may include a pair of cameras on either side of the HMD 810. Thus, stereoscopic views can be captured by the cameras and/or displayed to the user. In some cases, a VSLAM device 205, device 300, or device 375 may also include more than one image sensor 305 for stereoscopic image capture.

The HMD 810 does not include wheels 715, propellers 725, or other conveyance of its own. Instead, the HMD 810 relies on the movements of the user 820 to move the HMD 810 about the environment. Thus, in some cases, the HMD 810, when performing a VSLAM technique, can skip path planning using the path planning engine 260 and 364 and/or movement actuation using the movement actuator 265. In some cases, the HMD 810 can still perform path planning using the path planning engine 260 and 364 and can indicate directions to follow a suggested path to the user 820 to direct the user along the suggested path planned using the path planning engine 260 and 364. In some cases, for instance, where the HMD 810 is a VR headset, the environment may be entirely or partially virtual. If the environment is at least partially virtual, then movement through the virtual environment may be virtual as well. For instance, movement through the virtual environment can be controlled by one or more joysticks, buttons, video game controllers, mice, keyboards, trackpads, and/or other input devices. The movement actuator 265 may include any such input device. Movement through the virtual environment may not require wheels 715, propellers 725, legs, or any other form of conveyance. If the environment is a virtual environment, then the HMD 810 can still perform path planning using the path planning engine 260 and 364 and/or movement actuation 265. If the environment is a virtual environment, the HMD 810 can perform movement actuation using the movement actuator 265 by performing a virtual movement within the virtual environment. Even if an environment is virtual, VSLAM techniques may still be valuable, as the virtual environment can be unmapped and/or generated by a device other than the VSLAM device 205, device 300, or device 375, such as a remote server or console associated with a video game or video game platform. In some cases, VSLAM may be performed in a virtual environment even by a VSLAM device 205, device 300, or device 375 that has its own physical conveyance system that allows it to physically move about a physical environment. For example, VSLAM may be performed in a virtual environment to test whether a VSLAM device 205, device 300, or device 375 is working properly without wasting time or energy on movement and without wearing out a physical conveyance system of the VSLAM device 205, device 300, or device 375.

FIG. 8C is a perspective diagram 840 illustrating a front surface 855 of a mobile handset 850 that performs VSLAM using front-facing cameras 310 and 315, in accordance with some examples. The mobile handset 850 may be, for example, a cellular telephone, a satellite phone, a portable gaming console, a music player, a health tracking device, a wearable device, a wireless communication device, a laptop, a mobile device, or a combination thereof. The front surface 855 of the mobile handset 850 includes a display screen 845. The front surface 855 of the mobile handset 850 includes at least one image sensor 305 and may include a depth sensor 380. The at least one image sensor 305 and may include a depth sensor 380 are illustrated in a bezel around the display screen 845 on the front surface 855 of the mobile device 850. In some examples, the at least one image sensor 305 and the depth sensor 380 can be positioned a notch or cutout that is cut out from the display screen 845 on the front surface 855 of the mobile device 850. In some examples, the at least one image sensor 305 and may include a depth sensor 380 can be under-display cameras that are positioned between the display screen and the rest of the mobile handset 850, so that light passes through a portion of the display screen before reaching the at least one image sensor 305 and may include a depth sensor 380. The at least one image sensor 305 and may include a depth sensor 380 of the perspective diagram 840 are front-facing. The at least one image sensor 305 and may include a depth sensor 380 face a direction perpendicular to a planar surface of the front surface 855 of the mobile device 850.

FIG. 8D is a perspective diagram 860 illustrating a rear surface 865 of a mobile handset 850 that performs VSLAM using rear-facing cameras 310 and 315, in accordance with some examples. The at least one image sensor 305 and may include a depth sensor 380 of the perspective diagram 860 are rear-facing. The at least one image sensor 305 and may include a depth sensor 380 face a direction perpendicular to a planar surface of the rear surface 865 of the mobile device 850. While the rear surface 865 of the mobile handset 850 does not have a display screen 845 as illustrated in the perspective diagram 860, in some examples, the rear surface 865 of the mobile handset 850 may have a display screen 845. If the rear surface 865 of the mobile handset 850 has a display screen 845, any positioning of the at least one image sensor 305 and may include a depth sensor 380 relative to the display screen 845 may be used as discussed with respect to the front surface 855 of the mobile handset 850.

Like the HMD 810, the mobile handset 850 includes no wheels 715, propellers 725, or other conveyance of its own. Instead, the mobile handset 850 relies on the movements of a user holding or wearing the mobile handset 850 to move the mobile handset 850 about the environment. Thus, in some cases, the mobile handset 850, when performing a VSLAM technique, can skip path planning using the path planning engine 260 and 364 and/or movement actuation using the movement actuator 265. In some cases, the mobile handset 850 can still perform path planning using the path planning engine 260 and 364 and can indicate directions to follow a suggested path to the user to direct the user along the suggested path planned using the path planning engine 260 and 366. In some cases, for instance, where the mobile handset 850 is used for AR, VR, MR, or XR, the environment may be entirely or partially virtual. In some cases, the mobile handset 850 may be slotted into a head-mounted device so that the mobile handset 850 functions as a display of HMD 810, with the display screen 845 of the mobile handset 850 functioning as the display of the HMD 810. If the environment is at least partially virtual, then movement through the virtual environment may be virtual as well. For instance, movement through the virtual environment can be controlled by one or more joysticks, buttons, video game controllers, mice, keyboards, trackpads, and/or other input devices that are coupled in a wired or wireless fashion to the mobile handset 850. The movement actuator 265 may include any such input device. Movement through the virtual environment may not require wheels 715, propellers 725, legs, or any other form of conveyance. If the environment is a virtual environment, then the mobile handset 850 can still perform path planning using the path planning engine 260 and 364 and/or movement actuation 265. If the environment is a virtual environment, the mobile handset 850 can perform movement actuation using the movement actuator 265 by performing a virtual movement within the virtual environment.

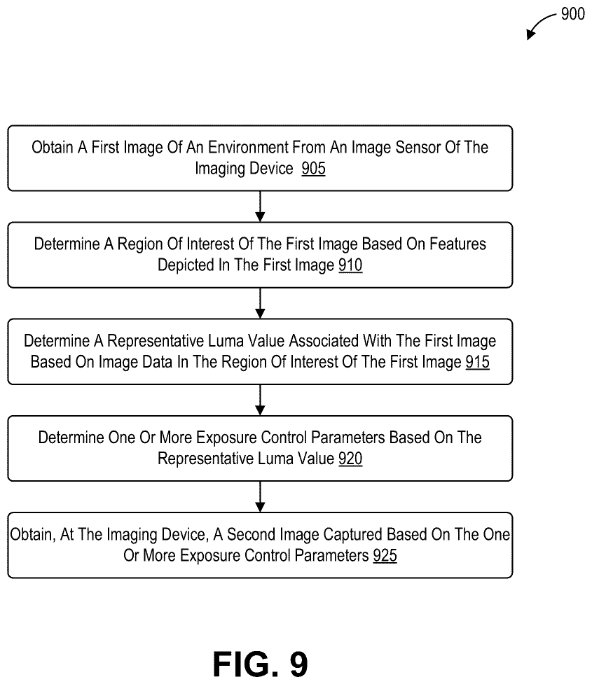

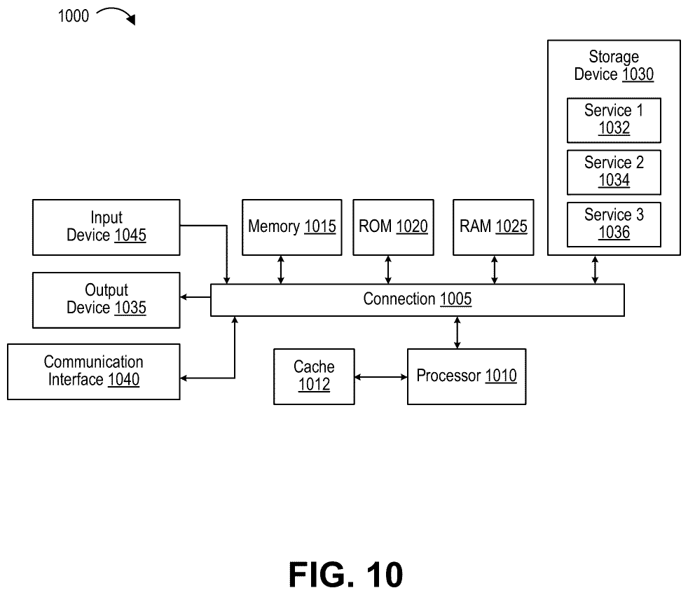

FIG. 9 is a flowchart illustrating an example of a method 900 for processing audio, in accordance with certain aspects of the present disclosure. The method 900 can be performed by a computing device that is configured to provide an audio stream, such as a mobile wireless communication device, an extended reality (XR) device (e.g., a VR device, AR device, MR device, etc.), a network-connected wearable device (e.g., a network-connected watch), a vehicle or component or system of a vehicle, a laptop, a tablet, or another computing device. In one illustrative example, the computing system 1000 described below with respect to FIG. 10 can be configured to perform all or part of the method 900.

The imaging device may obtain a first image of an environment from an image sensor of the imaging device at block 905. In this case, the first image may have lighter regions and darker regions as described above. The lighter regions may be farther away and the darker regions may be closer, which can cause issues with tracking accuracy based on insufficient exposure of objects having less depth of features.

The imaging device may determine a region of interest of the first image based on features depicted in the first image at block 910. The features may be associated with the environment and can include fixed features such as hardscaping, landscaping, vegetation, road signs, building, and so forth. The imaging device may determine the region of interest in the first image by predicting a location of the features associated with the environment in a 2D map. The 2D map corresponds to images obtained by the image sensor, and the imaging device may divide the 2D map into a plurality of bins, sort the bins based on a number of features and depths of the features, and select one or more candidate bins from the sorted bins.

In one illustrative aspect, the region of interest of the first image may be determined based on depth information obtained using a depth sensor of the imaging device. For example, the depth sensor may comprise at least one of a LiDAR sensor, a radar sensor, or a ToF sensor.

In one aspect, to predict the location of the features associated with the environment in the 2D map, the imaging device may determine a position and an orientation of the imaging device, obtain three 3D positions of features associated with a 3D map of the environment based on the position and the orientation of the imaging device within the environment, and map 3D positions of the features associated with the map into the 2D map based on the position and the orientation of the imaging device and the position of the image sensor. In some aspects, the 3D positions of features associated with the map can be provided by a mapping server. For example, the imaging device may transmit the position and the orientation of the imaging device to a mapper server and receive the 3D positions of features associated with the map from the mapper server. In another aspect, the imaging device may store a 3D map and, to obtain the 3D positions of the features associated with the map, the imaging device may determine the 3D positions of the features based on the 3D map stored in the imaging device using the position and the orientation of the imaging device.

The imaging device may select the one or more candidate bins from the sorted bins by determining a respective number of features in each bin from the plurality of bins, determining a respective depth of features within each bin from the plurality of bins, and determining the one or more candidate bins from the plurality of bins based on comparing each respective depth of features and each respective number of features in each bin to a depth threshold and a minimum number of features. For example, the features can be edges within the environment that correspond to a feature identified in the map, such as hardscaping. In one illustrative aspect, the imaging device may select a representative bin from the one or more candidate bins. For example, the imaging device may select the representative bin from the one or more candidate bins based on the number of features in the first bin being greater than the minimum number of features and the first bin having a greatest number of features below the depth threshold as compared to the one or more candidate bins.

The imaging device may determine a representative luma value associated with the first image based on image data in the region of interest of the first image at block 915. In one example, the representative luma can be determined by the imaging device based on determination of a representative luma value associated with the first image based only on the image data in the region of interest. For example, the representative luma can be determined based on the representative bin. In some aspects, the representative luma value is an average luma of the image data in the region of interest. In other aspects, the imaging device may determine the representative luma value based on the image data in the region of interest by determining the representative luma value associated with the first image based on scaling an average luma of the image data in the region of interest. For example, an average luma of the entire image can be determined, but pixels representative bin can be weighted to have greater impact for controlling image capture settings.

The imaging device may determine one or more exposure control parameters based on the representative luma value at block 920. In some aspects, the one or more exposure control parameters include at least one of an exposure duration or a gain setting.

The imaging device may obtain a second image captured based on the one or more exposure control parameters at block 925. The imaging device is configured to track a position of the imaging device in the environment based on a location of the features in the second image

FIG. 10 is a diagram illustrating an example of a system for implementing certain aspects of the present technology. In particular, FIG. 10 illustrates an example of computing system 1000, which can be for example any computing device making up an internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some aspects, computing system 1000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 1000 includes at least one processing unit (CPU or processor) 1010 and connection 1005 that couples various system components including system memory 1015, such as ROM 1020 and RAM 1025 to processor 1010. Computing system 1000 can include a cache 1012 of high-speed memory connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000. Computing system 1000 can include communications interface 1040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 1002.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some aspects, a hardware service that performs a particular function can include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. A method of processing one or more images, comprising: obtaining, at an imaging device, a first image of an environment from an image sensor of the imaging device; determining a region of interest of the first image based on features depicted in the first image, wherein the features are associated with the environment; determining a representative luma value associated with the first image based on image data in the region of interest of the first image; determining one or more exposure control parameters based on the representative luma value; and obtaining, at the imaging device, a second image captured based on the one or more exposure control parameters.
Aspect 2. The method of Aspect 1, wherein the one or more exposure control parameters include at least one of an exposure duration or a gain setting.
Aspect 3. The method of any of Aspects 1 to 2, wherein determining the one or more exposure control parameters based on the representative luma value comprises: determining at least one of an exposure duration or a gain setting for the second image based on the representative luma value.
Aspect 4. The method of any of Aspects 1 to 3, wherein determining the representative luma value based on the image data in the region of interest comprises: determining the representative luma value associated with the first image based only on the image data in the region of interest.
Aspect 5. The method of any of Aspects 1 to 4, wherein the representative luma value is an average luma of the image data in the region of interest.
Aspect 6. The method of any of Aspects 1 to 5, wherein determining the representative luma value based on the image data in the region of interest comprises: determining the representative luma value associated with the first image based on scaling an average luma of the image data in the region of interest.
Aspect 7. The method of any of Aspects 1 to 6, wherein determining the region of interest of the first image comprises: predicting, by the imaging device, a location of the features associated with the environment in a two-dimensional (2D) map, wherein the 2D map corresponds to images obtained by the image sensor; dividing the 2D map into a plurality of bins; sorting the bins based on a number of features and depths of the features; and selecting one or more candidate bins from the sorted bins.
Aspect 8. The method of any of Aspects 1 to 7, wherein predicting the location of the features associated with the environment in the 2D map comprises: determining a position and an orientation of the imaging device; obtaining three-dimensional (3D) positions of features associated with a 3D map of the environment based on the position and the orientation of the imaging device within the environment; and mapping, by the imaging device, 3D positions of the features associated with the map into the 2D map based on the position and the orientation of the imaging device and the position of the image sensor.
Aspect 9. The method of any of Aspects 1 to 8, wherein obtaining the 3D positions of features associated with the map comprises: transmitting the position and the orientation of the imaging device to a mapper server; and receiving the 3D positions of features associated with the map from the mapper server.
Aspect 10. The method of any of Aspects 1 to 9, wherein obtaining the 3D positions of the features associated with the map comprises: determining the 3D positions of the features based on the 3D map stored in the imaging device using the position and the orientation of the imaging device.
Aspect 11. The method of any of Aspects 1 to 10, wherein selecting the one or more candidate bins from the sorted bins comprises: determining a respective number of features in each bin from the plurality of bins; determining a respective depth of features within each bin from the plurality of bins; and determining the one or more candidate bins from the plurality of bins based on comparing each respective depth of features and each respective number of features in each bin to a depth threshold and a minimum number of features.
Aspect 12. The method of any of Aspects 1 to 11, further comprising: selecting the first bin from the plurality of bins based on the number of features in the first bin being greater than the minimum number of features and the first bin having a greatest number of features below the depth threshold as compared to the one or more candidate bins.
Aspect 13. The method of any of Aspects 1 to 12, wherein the region of interest of the first image is determined based on depth information obtained using a depth sensor of the imaging device.
Aspect 14. The method of any of Aspects 1 to 13, wherein the depth sensor comprises at least one of a light detection and ranging (LiDAR) sensor, a radar sensor, or a time of flight (ToF) sensor.
Aspect 15. The method of any of Aspects 1 to 14, further comprising: tracking, at the imaging device, a position of the imaging device in the environment based on a location of the features in the second image.
Aspect 16. An apparatus for processing one or more images, comprising at least one memory and at least one processor coupled to the at least one memory, the at least one processor configured to: obtain a first image of an environment from an image sensor of the imaging device; determine a region of interest of the first image based on features depicted in the first image, wherein the features are associated with the environment; determine a representative luma value associated with the first image based on image data in the region of interest of the first image; determine one or more exposure control parameters based on the representative luma value; and obtain a second image captured based on the one or more exposure control parameters.
Aspect 17. The system of Aspect 16, wherein the one or more exposure control parameters include at least one of an exposure duration or a gain setting.
Aspect 18. The system of any of Aspects 16 to 17, wherein, to determine the one or more exposure control parameters based on the representative luma value, the at least one processor is configured to: determine at least one of an exposure duration or a gain setting for the second image based on the representative luma value.
Aspect 19. The system of any of Aspects 16 to 18, wherein, to determine the representative luma value based on the image data in the region of interest, the at least one processor is configured to: determine the representative luma value associated with the first image based only on the image data in the region of interest.
Aspect 20. The system of any of Aspects 16 to 19, wherein the representative luma value is an average luma of the image data in the region of interest.
Aspect 21. The system of any of Aspects 16 to 20, wherein, to determine the representative luma value based on the image data in the region of interest, the at least one processor is configured to: determine the representative luma value associated with the first image based on scaling an average luma of the image data in the region of interest.
Aspect 22. The system of any of Aspects 16 to 21, wherein, to determine the region of interest of the first image, the at least one processor is configured to: predict a location of the features associated with the environment in a 2D map, wherein the 2D map corresponds to images obtained by the image sensor; divide the 2D map into a plurality of bins; sort the bins based on a number of features and depths of the features; and select one or more candidate bins from the sorted bins.
Aspect 23. The system of any of Aspects 16 to 22, wherein, to predict the location of the features associated with the environment in the 2D map, the at least one processor is configured: determine a position and an orientation of the imaging device; obtain three-dimensional (3D) positions of features associated with a 3D map of the environment based on the position and the orientation of the imaging device within the environment; and map 3D positions of the features associated with the map into the 2D map based on the position and the orientation of the imaging device and the position of the image sensor.
Aspect 24. The system of any of Aspects 16 to 23, wherein, to obtain the 3D positions of features associated with the map, the at least one processor is configured to: transmit the position and the orientation of the imaging device to a mapper server; and receive the 3D positions of features associated with the map from the mapper server.
Aspect 25. The system of any of Aspects 16 to 24, wherein, to obtain the 3D positions of the features associated with the map, the at least one processor is configured to: determine the 3D positions of the features based on the 3D map stored in the imaging device using the position and the orientation of the imaging device.
Aspect 26. The system of any of Aspects 16 to 25, wherein, to select the one or more candidate bins from the sorted bins, the at least one processor is configured to: determine a respective number of features in each bin from the plurality of bins; determine a respective depth of features within each bin from the plurality of bins; and determine the one or more candidate bins from the plurality of bins based on comparing each respective depth of features and each respective number of features in each bin to a depth threshold and a minimum number of features.
Aspect 27. The system of any of Aspects 16 to 26, wherein the at least one processor is configured to: select the first bin from the plurality of bins based on the number of features in the first bin being greater than the minimum number of features and the first bin having a greatest number of features below the depth threshold as compared to the one or more candidate bins.
Aspect 28. The system of any of Aspects 16 to 27, wherein the region of interest of the first image is determined based on depth information obtained using a depth sensor of the imaging device.
Aspect 29. The system of any of Aspects 16 to 28, wherein the depth sensor comprises at least one of a light detection and ranging (LiDAR) sensor, a radar sensor, or a time of flight (ToF) sensor.
Aspect 30. The system of any of Aspects 16 to 29, wherein the at least one processor is configured to: track a position of the imaging device in the environment based on a location of the features in the second image.
Aspect 31. A non-transitory computer-readable medium having stored thereon instructions that, when executed by one or more processors, cause the one or more processors to perform operations according to any of Aspects 1 to 15.
Aspect 32. An apparatus for processing one or more images including one or more means for performing operations according to any of Aspects 1 to 15.

What is claimed is:

1. A method of processing one or more images, comprising:
obtaining, at an imaging device, a first image of an environment from an image sensor of the imaging device;
determining a region of interest of the first image based on features depicted in the first image, wherein the features are associated with the environment;
determining a representative luma value associated with the first image based on image data in the region of interest of the first image;
determining one or more exposure control parameters based on the representative luma value; and
obtaining, at the imaging device, a second image captured based on the one or more exposure control parameters.

2. The method of claim 1, wherein the one or more exposure control parameters include at least one of an exposure duration or a gain setting.

3. The method of claim 1, wherein determining the one or more exposure control parameters based on the representative luma value comprises:
determining at least one of an exposure duration or a gain setting for the second image based on the representative luma value.

4. The method of claim 1, wherein determining the representative luma value based on the image data in the region of interest comprises:
determining the representative luma value associated with the first image based only on the image data in the region of interest.

5. The method of claim 1, wherein the representative luma value is an average luma of the image data in the region of interest.

6. The method of claim 1, wherein determining the representative luma value based on the image data in the region of interest comprises:
determining the representative luma value associated with the first image based on scaling an average luma of the image data in the region of interest.

7. The method of claim 1, wherein determining the region of interest of the first image comprises:
predicting, by the imaging device, a location of the features associated with the environment in a two-dimensional (2D) map, wherein the 2D map corresponds to images obtained by the image sensor;
dividing the 2D map into a plurality of bins;
sorting the bins based on a number of features and depths of the features; and
selecting one or more candidate bins from the sorted bins.

8. The method of claim 7, wherein predicting the location of the features associated with the environment in the 2D map comprises:
determining a position and an orientation of the imaging device;
obtaining three-dimensional (3D) positions of features associated with a 3D map of the environment based on the position and the orientation of the imaging device within the environment; and
mapping, by the imaging device, 3D positions of the features associated with the map into the 2D map based on the position and the orientation of the imaging device and the position of the image sensor.

9. The method of claim 8, wherein obtaining the 3D positions of features associated with the map comprises:
transmitting the position and the orientation of the imaging device to a mapper server; and
receiving the 3D positions of features associated with the map from the mapper server.

10. The method of claim 8, wherein obtaining the 3D positions of the features associated with the map comprises:
determining the 3D positions of the features based on the 3D map stored in the imaging device using the position and the orientation of the imaging device.

11. The method of claim 7, wherein selecting the one or more candidate bins from the sorted bins comprises:
determining a respective number of features in each bin from the plurality of bins;
determining a respective depth of features within each bin from the plurality of bins; and
determining the one or more candidate bins from the plurality of bins based on comparing each respective depth of features and each respective number of features in each bin to a depth threshold and a minimum number of features.

12. The method of claim 11, further comprising:
selecting the first bin from the plurality of bins based on the number of features in the first bin being greater than the minimum number of features and the first bin having a greatest number of features below the depth threshold as compared to the one or more candidate bins.

13. The method of claim 1, wherein the region of interest of the first image is determined based on depth information obtained using a depth sensor of the imaging device.

14. The method of claim 13, wherein the depth sensor comprises at least one of a light detection and ranging (LiDAR) sensor, a radar sensor, or a time of flight (ToF) sensor.

15. The method of claim 1, further comprising:
tracking, at the imaging device, a position of the imaging device in the environment based on a location of the features in the second image.

16. An apparatus comprising:
at least one memory; and
at least one processor coupled to at least one memory and configured to:
obtain a first image of an environment from an image sensor of an imaging device;
determine a region of interest of the first image based on features depicted in the first image, wherein the features are associated with the environment;
determine a representative luma value associated with the first image based on image data in the region of interest of the first image;
determine one or more exposure control parameters based on the representative luma value; and
obtain a second image captured based on the one or more exposure control parameters.

17. The apparatus of claim 16, wherein the one or more exposure control parameters include at least one of an exposure duration or a gain setting.

18. The apparatus of claim 16, wherein, to determine the one or more exposure control parameters based on the representative luma value, the at least one processor is configured to:
determine at least one of an exposure duration or a gain setting for the second image based on the representative luma value.

19. The apparatus of claim 16, wherein, to determine the representative luma value based on the image data in the region of interest, the at least one processor is configured to:
determine the representative luma value associated with the first image based only on the image data in the region of interest.

20. The apparatus of claim 16, wherein the representative luma value is an average luma of the image data in the region of interest.

21. The apparatus of claim 16, wherein, to determine the representative luma value based on the image data in the region of interest, the at least one processor is configured to:
determine the representative luma value associated with the first image based on scaling an average luma of the image data in the region of interest.

22. The apparatus of claim 16, wherein, to determine the region of interest of the first image, the at least one processor is configured to:
predict a location of the features associated with the environment in a two-dimensional (2D) map, wherein the 2D map corresponds to images obtained by the image sensor;
divide the 2D map into a plurality of bins;
sort the bins based on a number of features and depths of the features; and
select one or more candidate bins from the sorted bins.

23. The apparatus of claim 22, wherein, to predict the location of the features associated with the environment in the 2D map, the at least one processor is configured to:
determine a position and an orientation of the imaging device;
obtain three-dimensional (3D) positions of features associated with a 3D map of the environment based on the position and the orientation of the imaging device within the environment; and
map 3D positions of the features associated with the map into the 2D map based on the position and the orientation of the imaging device and the position of the image sensor.

24. The apparatus of claim 23, wherein, to obtain the 3D positions of features associated with the map, the at least one processor is configured to:
transmit the position and the orientation of the imaging device to a mapper server; and
receive the 3D positions of features associated with the map from the mapper server.

25. The apparatus of claim 23, wherein, to obtain the 3D positions of features associated with the map, the at least one processor is configured to:
determine the 3D positions of the features based on the 3D map stored in the imaging device using the position and the orientation of the imaging device.

26. The apparatus of claim 22, wherein, to select the one or more candidate bins from the sorted bins, the at least one processor is configured to:
determine a respective number of features in each bin from the plurality of bins;
determine a respective depth of features within each bin from the plurality of bins; and
determine the one or more candidate bins from the plurality of bins based on comparing each respective depth of features and each respective number of features in each bin to a depth threshold and a minimum number of features.

27. The apparatus of claim 26, wherein the at least one processor is configured to:
select the first bin from the plurality of bins based on the number of features in the first bin being greater than the minimum number of features and the first bin having a greatest number of features below the depth threshold as compared to the one or more candidate bins.

28. The apparatus of claim 16, wherein the region of interest of the first image is determined based on depth information obtained using a depth sensor of the imaging device.

29. The apparatus of claim 28, wherein the depth sensor comprises at least one of a light detection and ranging (LiDAR) sensor, a radar sensor, or a time of flight (ToF) sensor.

30. The apparatus of claim 16, wherein the at least one processor is configured to:
track a position of the imaging device in the environment based on a location of the features in the second image.
